(19) United States
(12) Patent Application Publication
(10) Pub. No.: US 2009/0146411 A1
(43) Pub. Date: Jun. 11, 2009

(54) Combinational articles as a pair

(76) Inventor: Hiromi Sakai, Otsu-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/314,071

(22) Filed: Dec. 3, 2008

(30) Foreign Application Priority Data
Dec. 7, 2007 (JP) 2007-316764

(51) Int. Cl. B42D 15/00; B42D 15/02

(52) U.S. Cl. 283/117; 283/63.1; 40/124.01

(57) ABSTRACT

Provided are combinational articles comprising, as a pair, a depiction of the front side of an object, the depiction being on a planar body and a depiction of the rear side of the same object, the depiction being on a separate planar body, and provided are also an ornament obtained by working the combinational articles into a form suitable for decoration as well as a card, a picture book, a room divider, an article of clothing and a painting each comprising the combinational articles.

### BACKGROUND OF THE INVENTION

1. Field of the Invention

The present invention relates to combinational articles comprising, as a pair, a depiction of the front side of an object, the depiction being on one planar body and a depiction of the rear side of the same object, the depiction being on a separate planar body, as well as to an ornament, a card, a picture book, a room divider, an article of clothing and a painting each using the same.

2. Description of the Related Art

In our ordinary life, we endlessly pursue comfort, coziness and bonds to other persons, whether being conscious or unconscious, and thereby we can feel some relief on the daily basis. Such relief is so essential for us that the trend to pursue comfort, coziness and bonds is increasingly growing in recent years, when our peace of mind is often disturbed by noise, pressure of business and human relationship at workplaces.

“Chi ni hatarakeba kado ga tatsu. Jo ni saosaseba nagasareru . . . . Tokaku ni hito no yo wa suminikui (Let intellect be your sole guide and you will become harsh and rigid. If you put a pole in a river of emotion, you will be swayed by it . . . . It is hard for people to live in this world).” This is an introductory part of “Kusamakura (The Three-Cornered World)” written by Soseki Natsume, who is the foremost Japanese novelist of the Meiji Era. Currently, something to make the hard world easier to live in if only a little, to increase comfort and to enrich our life is strongly desired.

In such circumstances, there is proposed the following method of drawing a picture as disclosed in Japanese Patent No. 2965554. In this method, foundations are applied onto both surfaces of a textile, and while this textile is used as a canvas, a composition viewed from one direction is drawn on one surface of the canvas. The textile is irradiated with light from the side where the composition is drawn, and essential parts of the composition, which is seen through the canvas, are traced on the other surface. Based on such parts, a background is drawn with imagination while adding actual scene and imaginary parts to the background. Thus, a picture on which scenes and objects of some relevance are drawn on the both surfaces of the canvas can be obtained. However, the disclosed method has the following problems. That is, since the scenes and the objects are drawn on both surfaces of the canvas, as long as the picture is used while being hung in such a large space that the both surfaces are visible, a person can appreciate the scenes and objects drawn on both surfaces. However, if there is no space behind for a person to step in, or the surface is a wall surface, those drawn on one surface remain unused and their purpose cannot be accomplished in the end.

In these circumstances, the present inventor exerted utmost efforts, originality and ingenuity and finally accomplished the present invention. A desired article relating to the present invention has been never known to anyone.

### SUMMARY OF THE INVENTION

It is an objective of the present invention to provide combinational articles useful for giving peace of mind and affluence to ordinary life of people, and effectively strengthening person-to-person bonds. More specifically, it is an objective of the present invention to provide combinational articles comprising, as a pair, a depiction of the front side of an object, the depiction being on a planar body and a depiction of the rear side of the object, the depiction being on a separate planar body; and an ornament obtained by working the combinational articles into a form suitable for decoration, as well as a card, a picture book, a room divider, an article of clothing and a painting each comprising the combinational articles.

The combinational articles intended by the present invention are provided as follows. A depiction of the front side of an object, the depiction being on a planar body and a depiction of the rear side of the object, the depiction being on a separate planar body are combined as a pair. That is, the combinational articles intended by the present invention are provided by use of the both depictions as an integrated and inseparable article in order to promote sense of solidarity and peace of mind.

The present invention relates to:

(1) combinational articles comprising, as a pair,
(a) a depiction of a front side of an object, the depiction being on a planar body and
(b) a depiction of a rear side of the object, the depiction being on a separate planar body;
(2) the combinational articles according to (1), wherein a color of the depiction of the front side of the object and that of the depiction of the rear side of the object constitutes any color combination of (i) a warm color and a cold color, (ii) a stimulating color and a tranquilizing color, (iii) an advancing color and a receding color, (iv) a loud color and a subdued color, (v) a tropical color and a natural color, or (vi) a soothing color and a pleasing color;
(3) the combinational articles according to (1) or (2), wherein an item that is not depicted on the depiction of the front side of the object is depicted on the depiction of the rear side of the object, or an item that is depicted on the depiction of the front side of the object is not depicted on the depiction of the rear side of the object;
(4) the combinational articles according to any one of (1) to (3), wherein the depiction is any one of a drawing with a painting tool selected from the group consisting of a black pencil, a color pencil, a color, a pastel, a pastel crayon, a crayon, a ballpoint pen, an ink pen, a marker, India ink and a paint; a photograph shot with a camera; and a print of an electronic image;
(5) the combinational articles according to any one of (1) to (4), wherein the planar body is any one of a paper, a cloth, a wooden board, a plastic, a slate, a glass and a metal;
(6) an ornament obtained by working the combinational articles according to any one of (1) to (5) into an ornamental article or a commemorative item;
(7) a card comprising the combinational articles according to any one of (1) to (5);
(8) a picture book comprising the combinational articles according to any one of (1) to (5);
(9) a room divider comprising the combinational articles according to any one of (1) to (5);
(10) an article of clothing comprising the combinational articles according to any one of (1) to (5); and
(11) a painting comprising the combinational articles according to any one of (1) to (5).

The combinational articles provided by the present invention comprises, as a pair, a depiction of the front side of an object, the depiction being on a planar body and a depiction of the rear side of the object, the depiction being on a separate planar body. Like an artifact of any type such as a sailing boat plastic model, a railroad locomotive model or a Davidson model, which is used as an ornamental article, the combinational articles which are worked to be suitable as an ornamental article used as a pair are useful as an ornament dressing up people's living space. Further, the worked articles are used as ornamental articles or accessories such as pendants, while friends, lovers, newlyweds, a married couple or the like own them one by one, thereby providing sense of unity or bonds between the two persons in a conscious or unconscious manner and making the hard world easier to live in. Not only a scene of hugging of lovers or newlyweds but also a scene of hugging of a grandchild and a grandfather or grandmother are depicted from the front and rear sides on separate planar bodies to provide paired articles. When each person owns one of the paired articles, the articles act similarly to a private mark or a tally and promote special feeling such as sense of solidarity or sense of unity between the two persons. Moreover, the sense of solidarity and peace of mind are achieved when two or more persons or one person own a unique world showing one theme from different directions.

The combinational articles as a pair obtained by the present invention are not only worked to be suitable for interior decoration and used as an ornament, but also worked into a pendant or the like and used as an accessory. Furthermore, the combinational articles as a pair obtained by the present invention are used for a card, a picture book, a room divider, an article of clothing or other industrial products. The present invention therefore is expected to be industrially applicable for various industrial products including an interior decoration, an accessory, a card, a picture book, a room divider and an article of clothing.

### BRIEF DESCRIPTION OF THE DRAWINGS

FIG. 1 is a depiction of the object which is a woman holding rabbits in her palms, the depiction being drawn from her front side.

FIG. 2 is a depiction of the same object as shown in FIG. 1, the depiction being drawn from her rear side. FIGS. 1 and 2 are paired to provide combinational articles.

FIG. 3 is a depiction of a woman facing rearward with a rabbit facing forward on her right shoulder, the depiction being drawn from the rabbit's front side.

FIG. 4 is a depiction of the same object as shown in FIG. 3, the depiction being drawn from the rear side of the rabbit on the shoulder. FIGS. 3 and 4 are paired to provide combinational articles.

FIG. 5 is a depiction of a woman facing rearward with rabbits in her palms and a parent dog facing forward. FIGS. 5 and 1 are paired to provide combinational articles.

FIG. 6 is a depiction of the same woman as shown in FIG. 5, the depiction being drawn from her front side. In the depiction, a puppy facing forward is also drawn. FIGS. 6 and 5 or FIGS. 6 and 2 are independently paired to provide combinational articles.

FIG. 7 is a depiction of a woman facing forward with one rabbit in her arms and the other rabbit on her right shoulder. FIGS. 7 and 3 or FIGS. 7 and 8 are independently paired to provide combinational articles.

FIG. 8 is a depiction of the same woman as shown in FIG. 7, the depiction being drawn from her rear side. In the depiction, a rabbit facing forward on her right shoulder and a boy facing forward are also drawn. FIGS. 8 and 4 are paired to provide combinational articles.

FIG. 9 is a depiction of a dog facing forward, and a glove and a doghouse behind the dog, the depiction being drawn from the dog's front side.

FIG. 10 is a depiction of the same dog as shown in FIG. 9, the depiction being drawn from the dog's rear side. In the depiction, a boy facing forward near the dog while sitting down is also drawn. FIGS. 9 and 10 are paired via the dog, both sides of which are drawn in the respective depictions, to provide combinational articles.

### DESCRIPTION OF THE PREFERRED EMBODIMENTS

The present invention provides combinational articles comprising, as a pair, a depiction of the front side of an object, the depiction being on a planar body and a depiction of the rear side of the same object, the depiction being on a separate planar body. According to the present invention, the front side of the object refers to one surface of the object a viewer appreciates and the rear side refers to the other surface opposite to the surface of the object the viewer appreciates. The relationship between the front side and the rear side is as follows. Usually, a surface of the object which the viewer can observe from an optional direction is the front side of the object and a surface of the object which the viewer can observe from the opposite direction to the above direction is the rear side of the object. The same shall apply hereafter.

Examples of the object include not only a person but also a domestic animal such as a dog, a cat, cattle, a horse or a swine, an insect such as a butterfly, a dragonfly, a cicada or a beetle, a sculpture, other drawing objects and a combination thereof. Furthermore, a combination of one of these objects and a landscape is considered as the object. Usually, a work showing the front side of the object and a work showing the rear side thereof even independently serve as a work. However, the present invention provides added value to production of a plurality of works suitable for a combination. That is, a motif for the combinational articles (hereinafter, also referred to as “paired paintings”) according to the present invention is preferably suitable for a commemorative item, and the examples include a theme or a scene each of which is romantic or commemorable and memorable.

A motif suitable for the paired paintings is something peculiar for an owner (a client) or something special with affection and value and is not limited to people, animals, plants, still objects, mineral substances or the universe.

The paired paintings may be representational, impressionistic or image paintings.

The paired paintings are characterized in that a person owning and decorating one of the pair can communicate mentally with the other person owning the other painting, whenever viewing the painting.

A material of the paired paintings such as a tool for representation is not limited, and a color or the like of the paired paintings is not limited. Moreover, the paired paintings may be different from mirrored images, mirror reverse images or the like each provided on a copy machine, a personal computer or the like.

The planar body according to the present invention refers to a medium on which a figure of an object is depicted. Examples of the planar body include one adequate for depiction of the figure of the object and one known per se, such as a paper, a cloth, a wooden board, a plastic, a slate, a glass and a metal plate regardless of types. For example, the paper means a paper that can be used for painting, sketching, writing or the like, and any type of so-called paper may be used. Examples of the paper include any type of paper known per se, such as Japanese paper made from a bast fiber such as stout smooth paper, thick Japanese paper, fine crepe paper, Sugihara-gami, hemp paper or ryoushi (paper for writing and painting), or foreign paper made from pulp such as printing paper, wrapping paper, simili paper, roll paper or paperboard. The cloth means a woven cloth made of a natural fiber, a synthetic fiber, a glass fiber, a mixture thereof or the like, and the examples include cloths produced by plain weave, satin weave, twill weave, horizontal stripe weave, leno weave, basket weave or the like. The cloth known per se used as a canvas for an oil painting is the most popular and particularly suitable for use because of easy availability. Further, the wooden board literally means a board made of wood, and the plastic refers to a sheet of a synthetic resin. Examples of the plastic include plastics known per se, such as a sheet made of acrylic acid, methacrylic acid, a polymer composed of one or more kinds of an ester thereof, polyethylene, polypropylene, polystyrene, polyvinyl chloride, polyester or a combination thereof, but they are not limited thereto.

A separate planar body literally refers to one planar body separate from another and also refers to a different part of the same planar body. The same shall apply hereafter.

A size of the planar body depends on how to use combinational articles according to the present invention comprising, as a pair, a depiction of the front side of the object and a depiction of the rear side thereof. If the combinational articles are used in a relatively wide space such as a hall or a living room, the planar body is preferably in such a size that it fits the space. If the combinational articles are used in a small size as an accessory, they are preferably in such a size that they do not disturb users' physical movements even if the users wear them. The front side and the rear side of the object may be depicted either in an equal size or in a different size.

The depictions mean ones in which the front side and the rear side of the object are depicted on separate planar bodies. A depiction means is not particularly limited, but suitably used is customary one known per se, such as India ink, a black pencil, a color pencil, a color (a water color, an oil color), a pastel, a pastel crayon, a crayon, a ballpoint pen, an ink pen, a marker and a paint of an appropriate color (including a fluorescent paint disclosed in Japanese Patent Application Laid-Open No. 2002-127696 by the present inventor). In addition to these means, a method using a laser beam or a sand blasting method, etc. is suitably used depending on the kind of the planar body. If the combinational articles are photographs, not only a photographic paper but also a slate and a metal plate can be used, and the photographs can be obtained through procedures known per se from shooting to printing. Moreover, an electronic image displayed on a computer monitor or a television monitor may be printed with a known printer or the like. The pair paintings of the present invention includes not only multicolor paired paintings but also paintings with uniform tone such as line drawings, monochrome paintings and ink brush drawings, and pen drawings represented by lines, dots and/or planes. The depiction means for the front side of the object and that for the rear side thereof may be either the same or different. The depiction of the front side of the object and that of the rear side thereof may have contours (silhouettes), respectively. An element other than the object may be depicted on the planar body on which the front side or the rear side of the object is depicted. As for the element other than the object, the front side and the rear side of the element are not required to be paired.

“The both depictions are used as a pair” means that the depiction of the front side of the object and the depiction of the rear side of the object are placed so that a viewer can view these depictions while comparing them with each other. The viewer can thereby simultaneously observe a figure of the front side of the object and that of the rear side of the object. Examples of the “pair” include a depiction of the front side of the object and a depiction of the rear side of the object displayed on two respective articles of the same type, those displayed at respective different positions of one article and those displayed on two respective articles of different types. Moreover, the different positions of one article may be different positions on the same side or positions on different sides such as a front surface and a rear surface, a side surface and an upper surface, a side surface and a bottom surface, or an upper surface and a bottom surface. If the depictions are displayed respectively on opposite surfaces such as a front surface and a rear surface, the depiction of the front side of the object and that of the rear side of the object may be aligned or not aligned with each other in position. Furthermore, “the both depictions are used as a pair” also means that a pair of articles is owned by different persons linked to each other, one by one so as to bond the two persons to each other.

In the combinational articles according to the present invention, it is preferable that a color of the depiction of the front side of the object and a color of the depiction of the rear side thereof constitutes any color combination of a warm color and a cold color, an stimulating color and a tranquilizing color, a deep color and a light color, a hard color and a soft color, an advancing color and a receding color, a loud color and a subdued color, a tropical color and a natural color, or a soothing color and a pleasing color. The advancing color is also referred to as an “expansive color” and the receding color is also referred to as a “contracting color”. Moreover, a combination of like colors, similar colors or resonant colors, in which colors are synchronized each other, can be suitably used.

The “warm color” generally means a hue from violet-red to red, red to orange and orange to yellow, whereas the “cold color” generally means a hue from blue-green to blue and blue to blue-violet. It is said that a warm-colored room and a cold-colored room differ in the wind-chill temperature by about 3° C. even at the same room temperature. An owner of the paired paintings having a warm color in one of the paintings and a cold color in the other painting may decorate a room with a depiction of the cold color in a period of high temperature, and may decorate the room with a depiction of the warm color in a period of low temperature, thereby making it possible to curb cooling and heating expense. Such an effect is considered to be effective for prevention of global warming and the owner thus can achieve peace of mind. Moreover, if the paired paintings are separately owned by different persons, that is, a person living in a hot region and a person living in a cold region, the person living in the hot region may own the depiction of the cold color and the person living in the cold region may own the depiction of the warm color, thereby making it possible to curb cooling and heating expense and promoting the sense of unity or the sense of solidarity between the two persons.

Generally, a warm and high chroma color is highly stimulating and referred to as a “stimulating color” whereas a cold, low chroma and low value color is referred to as a “tranquilizing color”. The stimulating color is a color raising blood pressure and cheering up a person, whereas the tranquilizing color is a color lowering blood pressure and calming down a person. Accordingly, if the paired paintings having the stimulating color in one of the paintings and the tranquilizing color in the other painting are separately owned by a senior person (a grandfather or a grandmother) and a child (a grandson or a granddaughter), the senior person can be cheered up and enjoy his or her improved health condition by owning the stimulating colored painting, and the child can study calmly by owning the tranquilizing colored painting. Moreover, both the senior person and the child can achieve their peace of mind and the sense of unity or sense of solidarity.

Generally, a halftone color, an earth color or a somber grayish color is referred to as a “soothing color” whereas a vivid color tone, a bright color or a clear color is referred to as a “pleasing color”. It is said that the soothing color is a color that can comfort a person in his or her sorrow, loneliness or sadness, and that the pleasing color is a color that can give a person joy, blessing or happiness. Accordingly, the combinational articles according to the present invention can promote the sense of unity or sense of solidarity between two persons each being put in different situations or living in different situations.

If two objects of the same size are viewed from the same distance, a color of the object appearing closer is referred to as an “advancing color” and a color of the object appearing more distant is referred to as a “receding color”. The advancing color is also referred to as an “expansive color” since the object of the advancing color appears to be larger than its actual size whereas the receding color is also referred to as a “contracting color” since the object of the receding color appears to be smaller than its actual size. A warm color having a long wavelength such as red, orange or yellow is the advancing color (expansive color) whereas a cold color having a short wavelength such as blue-green, blue or blue-violet is the receding color (contracting color).

A high chroma color is referred to as a “loud color” whereas a low chroma color is referred to as a “subdued color”. Even red has its subdued colors and even blue has its loud colors regardless of hue. A tropical color is a rich color that is associated with southern countries or southern fruits therein. A natural color is a fundamental color of a substance naturally present on the earth such as an earth color.

Like colors mean colors of the same hue such as red and pink. Similar colors mean colors having uniformity. While the same or similar hues are used, changing brightness or tone can provide a variety to colors. Resonant colors mean colors interacting and beautifully resonating with each other. As an example, complementary color contrast is given.

Color combinations are diverse but roughly classified into a combination of group colors or a combination of contrast colors used for variety's sake. Furthermore, a color unifying entire coloration is referred to as a “dominant color”. Use of the dominant color can produce uniformity and harmony in a common color. To create balance, accent and contrast, various effects of clear colors, muddy colors, brightness, saturation and hue can be used. Generally, a subdued color is made by adding a grayish color to a clear color.

Utilizing contrast and resonant effects of various colors, the combinational articles according to the present invention can provide varieties of industrial products. As for the contrast effects, temporal variations, i.e., morning and evening variations can be produced by using the effect of cold and warm colors and/or the effect of bright and dark colors, or each of paired colors can produce its maximum effect by using the relationship of complementary colors at opposite positions on a color wheel. Simultaneous contrast utilizes a mechanism that an eye perceives an optional color and its complementary color simultaneously. Also, changing saturations can produce a soothing effect and a pleasing effect on even the same color. Using the depth and area of a color can be expected to be useful for games for children or senior persons.

The combinational articles according to the present invention may be any as long as a depiction of the front side of the main object is displayed on one of the combinational articles (paired paintings) whereas a depiction of the rear side thereof is displayed on the other article (painting). An item depicted in parts other than the main object and in parts overlapped by the main object is not limited. That is, an item that is not depicted on the depiction of the front side of the object may be depicted on the depiction of the rear side thereof, or an item that is depicted on the depiction of the front side of the object may not be depicted on the depiction of the rear side thereof. By using the paired paintings including an item depicted only on one depiction, it is possible to enjoy a game for competing in memory or second sight. Moreover, the combinational articles according to the present invention can be used for a teaching material promoting or intended for promoting brain development of infants or children, a tool for preventing senility (dementia in particular) and the like. An owner of such paired paintings can achieve peace of mind through brain development or senility prevention.

An ornament according to the present invention means an worked article obtained by working a depiction of the front side of an object on a planar body and a depiction of the rear side of the object on a separate planar body into a form so that the combinational articles as a pair can be used for decoration. For example, firstly, to protect of the surface of the planar body on which the object is depicted, a transparent resin is applied onto the surface and dried, or a transparent film is attached onto the surface. Secondly, the planar body is worked so as to be hung in a frame on a wall, to be set upright on a table like a photo frame, or to be used as a pendant-like article. Furthermore, it is also possible in the present invention that the depiction of the front side of the object and the depiction of the rear side thereof are worked independently and the resultants are arranged in position and used as ornamental articles. Besides, the depiction of the front side of the object and the depiction of the rear side thereof may be worked independently into ornaments of different types (such as a pendant and a wall ornament).

A card according to the present invention may be any as long as it comprises the combinational articles according to the present invention. The combinational articles are preferably such that an item that is not depicted on the depiction of the front side of the object is depicted on the depiction of the rear side thereof, or an item that is depicted on the depiction of the front side of the object is not depicted on the depiction of the rear side thereof. Each of paired paintings may be displayed on a different card, but they are preferably displayed on the front surface and the rear surface of the same card, respectively. This is because by turning the card back, it is possible to easily check what appears or what disappears on the other painting. The card according to the present invention can be embodied as a game for competing in memory or second sight, a teaching material promoting or intended for promoting brain development of infants or children, or a card for preventing senility (dementia in particular). An owner of the card according to the present invention can achieve peace of mind through brain development or senility prevention.

A picture book according to the present invention may be any as long as it comprises the combinational articles according to the present invention. The combinational articles are preferably such that an item that is not depicted on the depiction of the front side of the object is depicted on the depiction of the rear side thereof, or an item that is depicted on the depiction of the front side of the object is not depicted on the depiction of the rear side thereof. Each of paired paintings may be displayed on a different page or a different spread. If each of the paired paintings is displayed on a different page, they may be displayed on respective adjacent pages on one spread, but preferably displayed on respective different spreads and more preferably displayed on continuously adjacent spreads, respectively. If each of the paired paintings is displayed on a different spread, they may be displayed on respective distant spreads, but preferably displayed on continuously adjacent spreads, respectively. This is because by turning pages, it is possible to easily check what appears or what disappears on the other painting. The picture book according to the present invention can be embodied as a game for competing in memory or second sight, a teaching material promoting or intended for promoting brain development of infants or children, or a book for preventing senility (dementia in particular). An owner of the picture book according to the present invention can achieve peace of mind through brain development or senility prevention.

A room divider according to the present invention may be any as long as it comprises the combinational articles according to the present invention. The room divider is also generally referred to as a “partition” and is not limited to any specific one as long as the room divider is used to divide a room. Specifically, examples of the room divider include a sliding door (fusuma), a standing screen, a screen, a movable wall, a scroll picture, a wall ornament (e.g. a tapestry) and a bar. Paired paintings may be displayed on one surface of the room divider or may be displayed on both respective surfaces of the room divider. If the paired paintings are displayed on both respective surfaces of the room divider, the depiction of the front side of the object and the depiction of the rear side thereof may be aligned or not aligned with each other in position. Use of the room divider according to the present invention can provide a spread of space that has been never provided. This effect enables even a narrow space to appear wide and open, and thus an effect of preventing claustrophobia can be expected, for example. Moreover, the spread of space can be provided and the space can be made to appear wide and open by depicting a landscape such as the beauty of nature or a dry Japanese garden, or a scene of an old and big pine tree from two directions such as north and south directions or east and west directions on a sliding door in a grand hall of, for example, a temple or a Japanese-style inn. Subsequently, an owner of the room divider according to the present invention or a person viewing the paired paintings displayed on the room divider can achieve peace of mind.

An article of clothing according to the present invention may be any as long as it comprises the combinational articles according to the present invention. Examples of the article of clothing include clothes, underwear and cloths, i.e., materials thereof. If paired paintings are displayed on, for example, a cloth, the paired paintings may be displayed on respective different cloths, displayed on one surface of the same cloth, or displayed respectively on the front surface and the rear surface of the same cloth. Materials of the cloth are not limited, and may be a combination of a canvas for one cloth and a synthetic fiber for the other cloth. A working method is not limited. Specific examples of displaying the paired paintings on an article of clothing include displaying the paired paintings respectively on the outer cloth and the inner cloth of a jacket or coat, but they not limited thereto. Alternatively, the paired paintings may be displayed only on the outer cloth, or conversely only on the inner cloth.

A type of a pattern is not limited and may be, for example, a picture pattern, a spaced pattern or a printed pattern. A size of the pattern is not limited and the patterns of the paired paintings may be either in an equal or different size. More specifically, a color combination of the paired paintings is changed based on a ground dyeing color, thereby making it possible to provide a variety of articles of clothing. Examples of the color combination include a combination of approximate colors, a combination of relative colors and a combination of opposite colors. Also, hue contrast, cold and warm contrast, complementary color contrast, simultaneous contrast, bright and dark contrast, area effect and saturation contrast, etc. can be utilized for the color combination.

Moreover, in the field of articles of clothing, if only the rear side of pattern can be newly produced using a conventional and existing pattern, a new application can be expected as “paired patterns” at half cost. Furthermore, since a conventional plate or mold can be reused, the present invention can be suitably used in the contemporary society, in which eco-friendly movements have been promoted around the globe.

Examples of the other applications of the combinational articles according to the present invention include use of handkerchiefs, mufflers, stoles, lap robes or the like as ordinary paired products or paired products for a man and a woman or for an adult and a child. Examples of the other applications also include displaying the paired paintings on an article of bedding such as a sheet, a cotton blanket or a pillowcase; displaying the paired paintings on the outer cloth and the inner cloth of a bag, a purse or a wallet; displaying the paired paintings on a surface of a stationery product such as a pocket notebook, a notebook or an eraser; displaying the paired paintings on two sides of a cover or a folding case of a book; displaying the paired paintings on tableware, for example, on both sides around the grip of a coffee cup; displaying the paired paintings on an outside and an inside of furniture, particularly a dresser with hinged double doors; and displaying the paired paintings on both sides of a round fan, a folding fan, a fan or the like.

Moreover, the paired paintings can be used as pet goods for a pet owner and a pet. Specifically, one of the paired paintings can be set on a wall as a painting for the pet owner and the other painting can be worked into a license tag or a pendant for the pet, so that both the pet owner and the pet can own the paired paintings. Alternatively, one of the paired paintings can be used as an article of clothing or a clothing ornament for the pet owner and the other painting can be used as an article for the pet upon walking outside.

Further, if the paired paintings are used in the field of scenic art or stage setting, a rendering effect different from a conventional one can be expected.

If the paired paintings are used in a billboard or an advertising pillar, viewers can pay attention to the billboard or the advertising pillar, making it possible to improve an advertising effect.

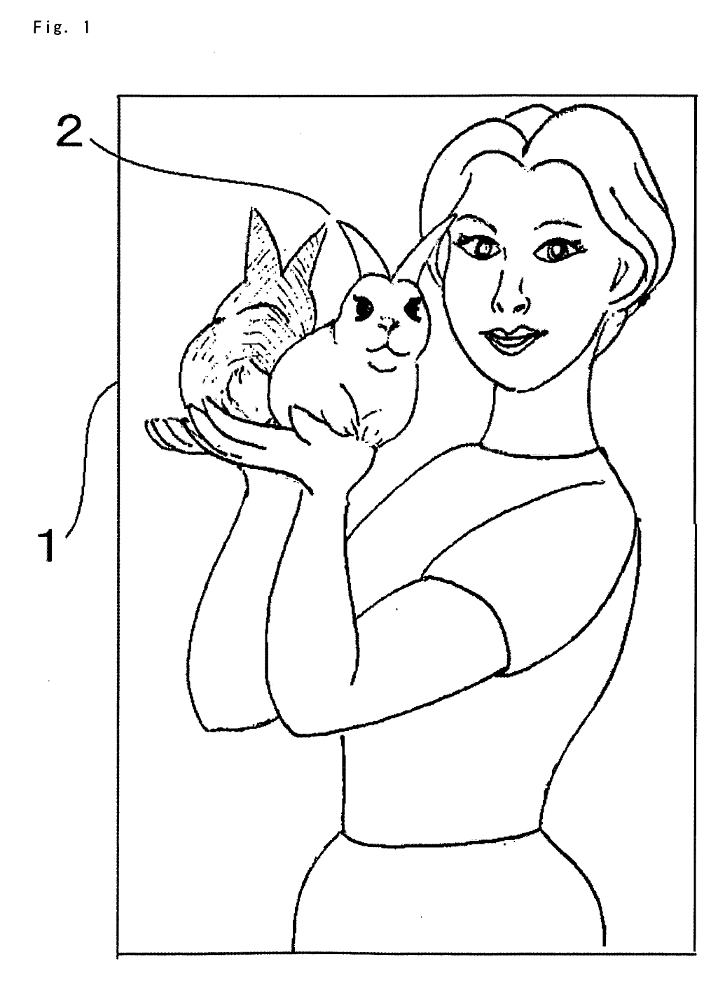

Hereinafter, specific embodiments of the combinational articles according to the present invention will be described with reference to FIGS. 1, 2, 3, 4, 5, 6, 7, 8, 9, and 10. It is to be noted, however, that the embodiments are not intended to limit the scope of the present invention or to influence the scope of the present invention.

FIG. 1 shows a depiction of the object 2 which is a woman holding rabbits in her palms, the depiction being drawn from her front side on the planar body 1 (drawing paper) with a black pencil. In the depiction, a rabbit faces forward in her left palm, and the other rabbit faces rearward in her right palm.

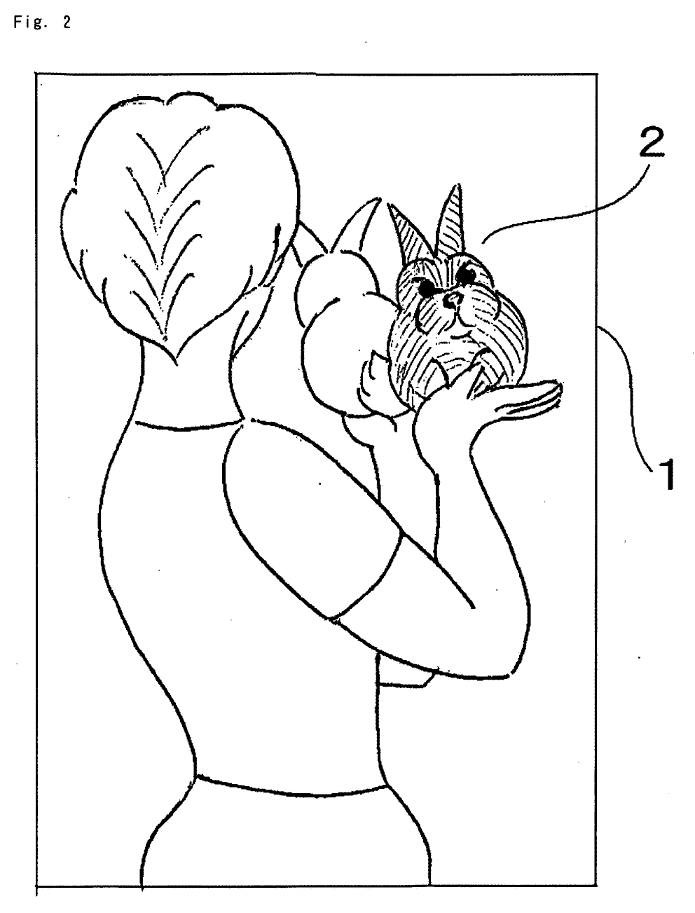

FIG. 2 shows a depiction of the same object 2 as shown in FIG. 1, the depiction being drawn from her rear side on the planar body 1 (drawing paper) with a black pencil.

The depictions shown in FIGS. 1 and 2 are paired as combinational articles to provide the desired article of the present invention. Furthermore, the paired depictions are separately set in frames that can be hung on a wall to provide ornaments. The depiction shown in FIG. 1 can be colored in a warm color and that shown in FIG. 2 can be colored in a cold color. A room divider displaying thereon the paired depictions shown in FIGS. 1 and 2 is provided. An article of clothing displaying thereon the paired depictions shown in FIGS. 1 and 2 is provided.

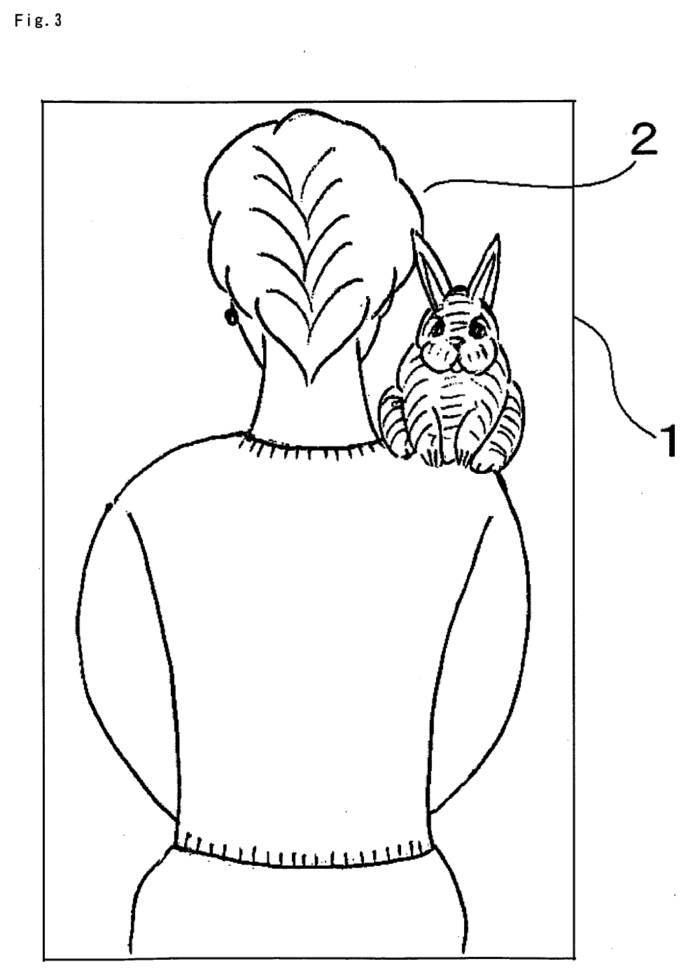

FIG. 3 shows a depiction of the object 2 which is a woman facing rearward with a rabbit facing forward on her right shoulder, the depiction being drawn from the rabbit's front side on the planar body 1 (drawing paper) with a black pencil.

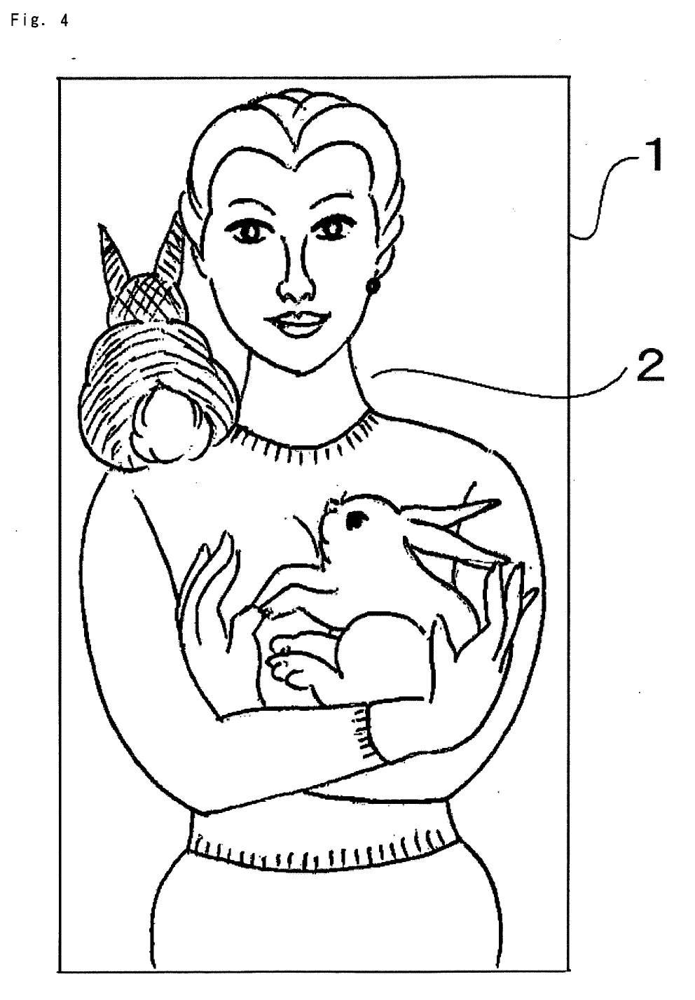

FIG. 4 shows a depiction of the same object 2 as shown in FIG. 3, the depiction being drawn on the planar body 1 (drawing paper) with a black pencil from the rear side of the rabbit on the woman's shoulder. The depictions shown in FIGS. 3 and 4 are paired as combinational articles to provide the desired article of the present invention. In the combinational articles of the paired depictions shown in FIGS. 3 and 4, the rabbit that is not shown in FIG. 3 is held in the arms of the woman in FIG. 4. The rabbit held in her arms is not recognized only by viewing the depiction shown in FIG. 3. The combinational articles of the paired depictions shown in FIGS. 3 and 4 are thus used as a teaching material promoting or intended for promoting brain development of infants and children, or a card or a picture book for preventing senility. Furthermore, the depiction shown in FIG. 3 can be colored in a warm color and that shown in FIG. 4 can be colored in a cold color. A room divider displaying thereon the paired depictions shown in FIGS. 3 and 4 is provided. An article of clothing displaying thereon the paired depictions shown in FIGS. 3 and 4 is provided. The paired depictions shown in FIGS. 3 and 4 are put into a frame while being arranged side by side and worked into a wall ornament as an ornament.

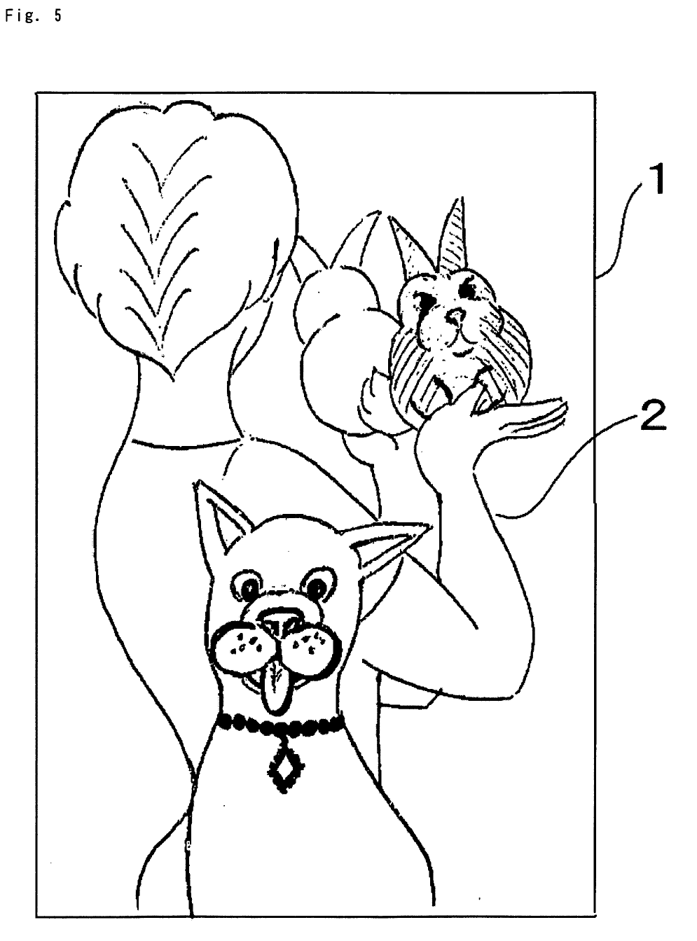

FIG. 5 shows a depiction of the object 2 which is a woman facing rearward with a rabbit facing forward and the other rabbit facing rearward in her palms, the depiction being drawn on the planar body 1. In the depiction, a parent dog facing forward is also drawn. The depictions shown in FIGS. 5 and 1 are paired to provide combinational articles. In the combinational articles of the paired depictions shown in FIGS. 5 and 1, the parent dog that is not shown in FIG. 1 is present behind the woman in FIG. 5. The parent dog is not recognized only by viewing the depiction shown in FIG. 1. The combinational articles of the paired depictions shown in FIGS. 1 and 5 are thus used as a teaching material promoting or intended for promoting brain development of infants and children, or a card or a picture book for preventing senility. Furthermore, the depiction shown in FIG. 1 can be colored in a tranquilizing color and that shown in FIG. 5 can be colored in a stimulating color. A room divider displaying thereon the paired depictions shown in FIGS. 1 and 5 is provided. An article of clothing displaying thereon the paired depictions shown in FIGS. 1 and 5 is provided. An ornament displaying thereon the paired depictions shown in FIGS. 1 and 5 is provided.

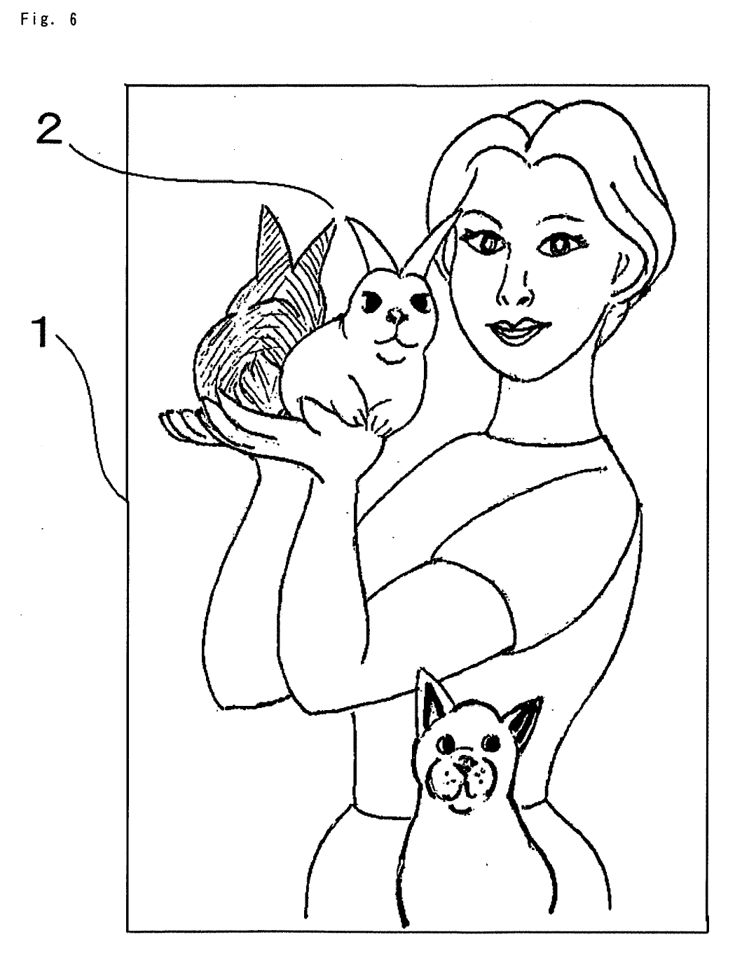

FIG. 6 shows a depiction of the object 2, i.e., the same woman as shown in FIG. 5, who faces forward and holds a rabbit facing forward and the other rabbit facing rearward in her palms, the depiction being drawn on the planar body 1. In the depiction, a puppy facing forward is also drawn. The depictions shown in FIGS. 6 and 5 or FIGS. 6 and 2 are paired to provide combinational articles. In the combinational articles of the paired depictions shown in FIGS. 5 and 6, the parent dog that is not shown in FIG. 6 is present behind the woman in FIG. 5, and the puppy that is not shown in FIG. 5 is present in FIG. 6. In the combinational articles of the paired depictions shown in FIGS. 2 and 6, the puppy that is not shown in FIG. 2 is present in FIG. 6. The combinational articles of the paired depictions shown in FIGS. 5 and 6 or FIGS. 2 and 6 are thus used as a teaching material promoting or intended for promoting brain development of infants and children, or a card or a picture book for preventing senility.

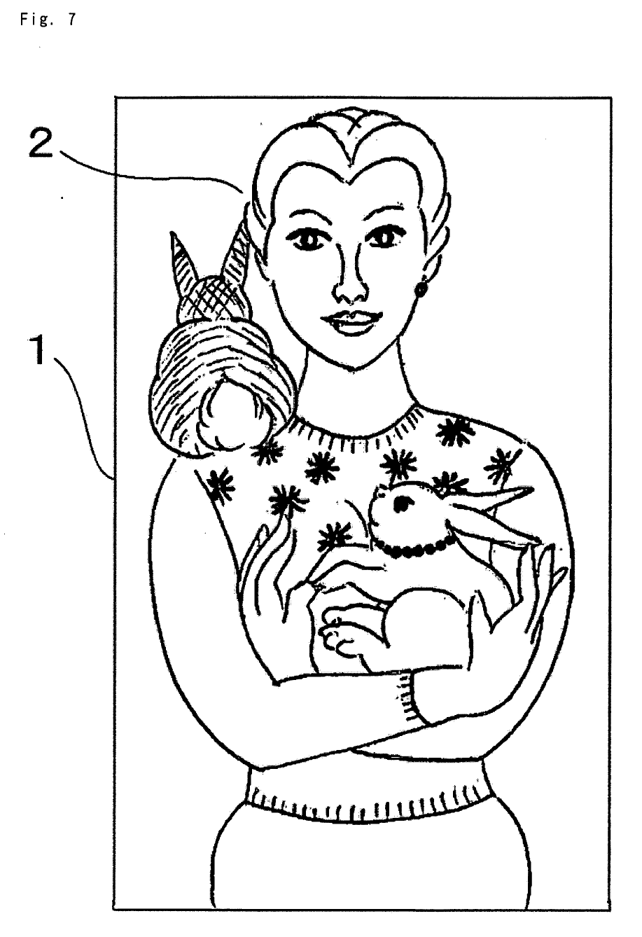

FIG. 7 shows a depiction of the object 2, i.e., a woman who faces forward with a rabbit facing rearward on her right shoulder and the other rabbit held in her arms, the depiction being drawn on the planar body 1.

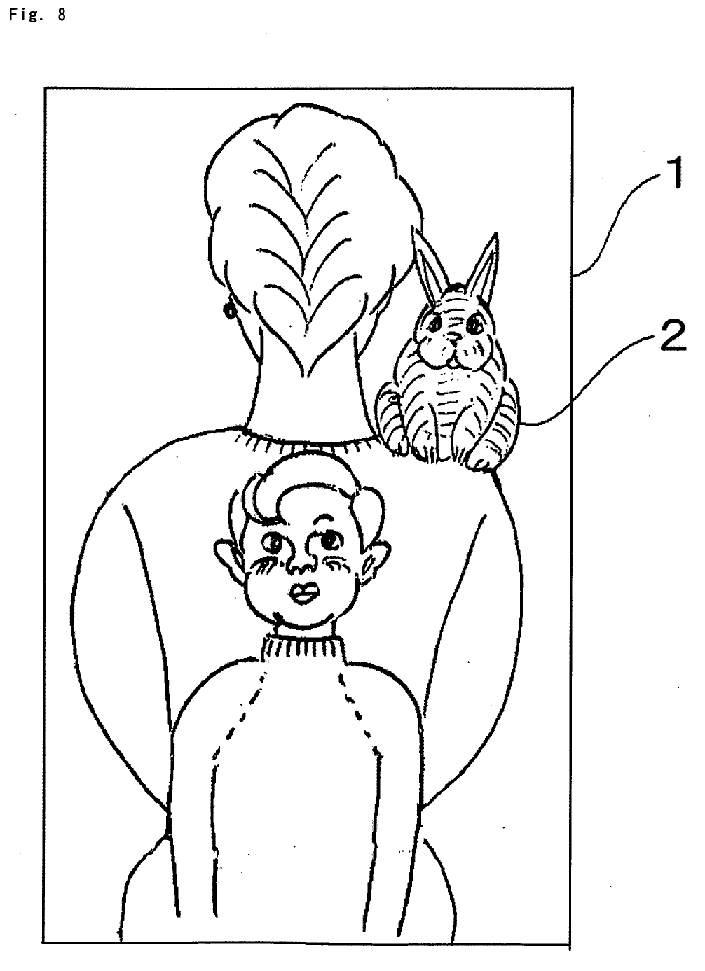

FIG. 8 shows a depiction of the object 2, which is a boy facing forward and the same woman as shown in FIG. 7, who faces rearward with a rabbit facing forward on her right shoulder, the depiction being drawn on the planar body 1. The depictions shown in FIGS. 7 and 3 or FIGS. 7 and 8 are paired to provide combinational articles. The depictions shown in FIGS. 8 and 4 are paired to provide combinational articles. In the combinational articles of the paired depictions shown in FIGS. 3 and 7, the rabbit that is not shown in FIG. 3 is held in the arms of the woman in FIG. 7, and a pattern of the woman's clothes is shown in FIG. 7. In the combinational articles of the paired depictions shown in FIGS. 7 and 8, the rabbit that is not shown in FIG. 8 is held in the arms of the woman in FIG. 7, and the boy that is not shown in FIG. 7 is present in FIG. 8. In the combinational articles of the paired depictions shown in FIGS. 4 and 8, the rabbit that is not shown in FIG. 8 is held in the arms of the woman in FIG. 4, and the boy that is not shown in FIG. 4 is present in FIG. 8. The combinational articles of the paired depictions shown in FIGS. 3 and 7, FIGS. 7 and 8 or FIGS. 4 and 8 are thus used as a teaching material promoting or intended for promoting brain development of infants and children, or a card or a picture book for preventing senility.

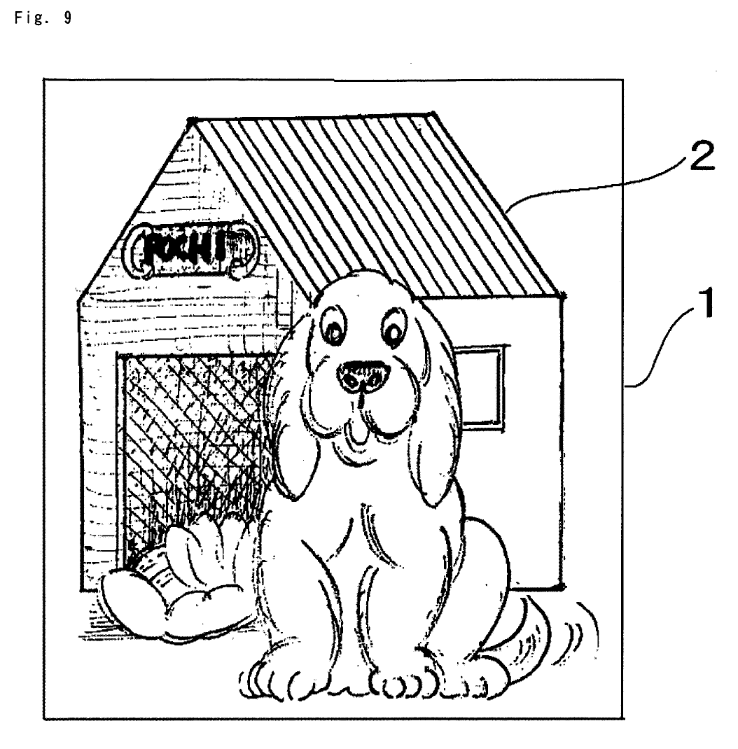

FIG. 9 shows a depiction of the object 2 which is a pet dog facing forward, wagging its tail and being called Pochi, the depiction being drawn on the planar body 1. In the depiction, a glove and a doghouse behind the pet dog are also drawn.

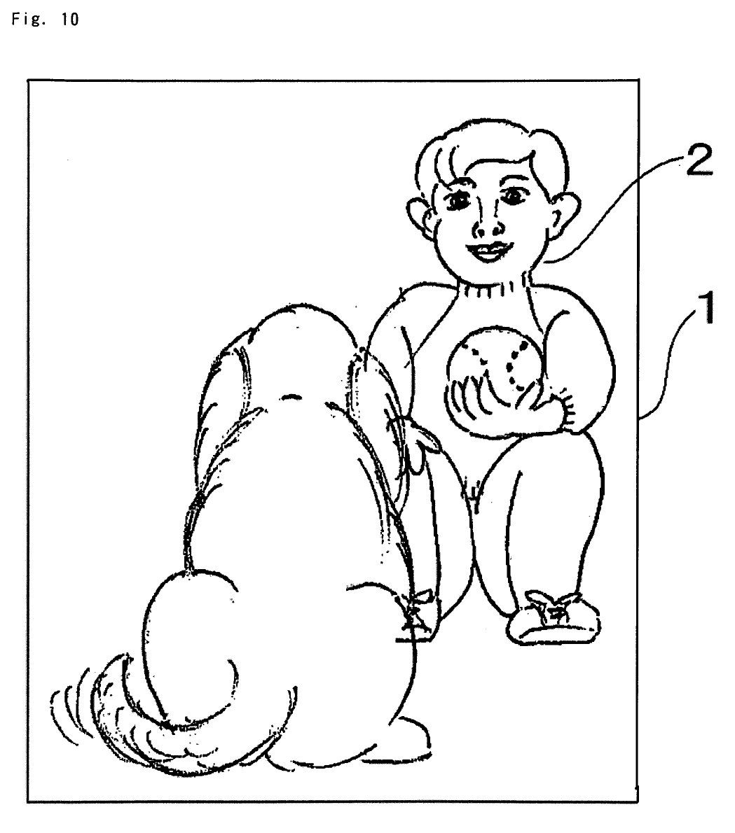

FIG. 10 shows a depiction of the object 2 which is a pet dog facing rearward, wagging its tail and being called Pochi, the depiction being drawn on the planar body 1. In the depiction, a friend boy facing the pet dog while sitting down and holding a ball in his hand is also drawn. The depictions shown in FIGS. 9 and 10 are paired via the dog, both sides of which are drawn in the respective depictions, to provide combinational articles. In the combinational articles of the paired depictions shown in FIGS. 9 and 10, the dog house that is not shown in FIG. 10 is present in FIG. 9 and the sitting boy with a ball in his hand that is not shown in FIG. 9 is present in FIG. 10. The combinational articles of the paired depictions shown in FIGS. 9 and 10 are thus used as a teaching material promoting and intended for promoting brain development of infants and children, or a card or a picture book for preventing senility. Furthermore, the depiction shown in FIG. 9 can be colored in a warm color and that shown in FIG. 10 can be colored in a cold color. A room divider displaying thereon the paired depictions shown in FIGS. 9 and 10 is provided. An article of clothing displaying thereon the paired depictions shown in FIGS. 9 and 10 is provided. An ornament displaying thereon the paired depictions shown in FIGS. 9 and 10 is provided.

1. Combinational articles comprising, as a pair,
(a) a depiction of a front side of an object, the depiction being on a planar body and
(b) a depiction of a rear side of the object, the depiction being on a separate planar body.

2. The combinational articles according to claim 1,
wherein a color of the depiction of the front side of the object and that of the depiction of the rear side of the object constitutes any color combination of (i) a warm color and a cold color, (ii) a stimulating color and a tranquilizing color, (iii) an advancing color and a receding color, (iv) a loud color and a subdued color, (v) a tropical color and a natural color, or (vi) a soothing color and a pleasing color.

3. The combinational articles according to claim 1,
wherein an item that is not depicted on the depiction of the front side of the object is depicted on the depiction of the rear side of the object, or an item that is depicted on the depiction of the front side of the object is not depicted on the depiction of the rear side of the object.

4. The combinational articles according to claim 1,
wherein the depiction is any one of a drawing with a painting tool selected from the group consisting of a black pencil, a color pencil, a color, a pastel, a pastel crayon, a crayon, a ballpoint pen, an ink pen, a marker, India ink and a paint; a photograph shot with a camera; and a print of an electronic image.

5. The combinational articles according to claim 1,
wherein the planar body is any one of a paper, a cloth, a wooden board, a plastic, a slate, a glass and a metal.

6. An ornament obtained by working the combinational articles according to claim 1 into an ornamental article or a commemorative item.

7. A card comprising the combinational articles according to claim 1.

8. A picture book comprising the combinational articles according to claim 1.

9. A room divider comprising the combinational articles according to claim 1.

10. An article of clothing comprising the combinational articles according to claim 1.

11. A painting comprising the combinational articles according to claim 1.
